(19) United States
(12) Patent Application Publication
(10) Pub. No.: US 2018/0125052 A1
(43) Pub. Date: May 10, 2018

(54) LUMINAIRE DISEASE VECTOR ATTENUATOR AND SURVEILLANCE DEVICE

(71) Applicant: GE Lighting Solutions, LLC, East Cleveland, OH (US)

(72) Inventor: David Mark JOHNSON, East Flat Rock, NC (US)

(21) Appl. No.: 15/343,870

(22) Filed: Nov. 4, 2016

(51) Int. Cl. A01M 1/02; H04N 7/18; A01M 1/04; A01M 1/06; A01M 1/22; A01M 5/00

(52) U.S. Cl. CPC A01M 1/026; H04N 7/188; A01M 1/023; A01M 5/00; A01M 1/06; A01M 1/223; A01M 1/04

(57) ABSTRACT

Provided is an insect monitoring device including a tube. An attractor is positioned at an entrance to the tube, and an imaging device is configured for producing data associated with a monitored insect, wherein the data being usable in machine learning.

### I. TECHNICAL FIELD

The present invention relates generally to attracting, destroying, and cataloging mosquitoes. In particular, the present invention relates to a device and method for capturing and classifying mosquitoes, and training software to identify mosquitoes in designated areas.

### II. BACKGROUND

Mosquitoes are one of the most deadly creatures on the planet. There are several mosquito-borne diseases including Malaria, West Nile Virus, and Zika Virus, just to name a few. Over a million people worldwide die from mosquito-borne diseases every year. In addition to humans, mosquitoes transmit diseases to animals, such as horses and dogs. Mosquito populations are abundant in a number of places, particularly those places in hot, moist environments. As a result, mosquitoes are a major health concern.

For example, West Nile Virus (WNV) has been detected in over 48 states in the United States (US) and outbreaks have occurred every summer since 1999. WNV causes fever and flu-like systems, and even death in humans. WNV is cycled between birds and mosquitoes and then transmitted to mammals, specifically humans. Nearly 44,000 cases of WNV have been reported in the US since 1999. Of those, over 20,000 people have had infections of the brain or spinal cord and more than 1,900 people have died.

The Zika Virus (Zika) is also spread by mosquitoes. Zika is particularly a threat to pregnant women and their unborn children. For example, Zika causes Guillain-Baire syndrome and a birth defect called microcephaly. Unfortunately, mosquitoes that cause Zika have been detected in the continental US.

Malaria is also a disease transmitted through mosquitoes. Although, the Centers for Disease Control (CDC) has eliminated Malaria as a major public health concern in the US, there are still approximately 1,500 cases documented in the US each year.

One conventional approach to monitoring mosquitoes is mosquito-based surveillance. Mosquito-based surveillance consists of the systematic collection of mosquito samples and screening them for arboviruses. Humans usually manually collect the mosquito samples for the mosquito based surveillance. During this process, humans ride on equipment, such as lawnmowers and tractors with nets, and collect mosquitoes for surveillance and examination.

The demand for mosquito control as a quality of life issue is likely to remain strong in many areas, even within the US. However, there are limitations to the current mosquito-based surveillance. For example, viruses may not be detected in the mosquito population if the infection rates are very low or if only small sample sizes are tested. Additionally, manual collection of mosquitoes is very time consuming.

### III. SUMMARY

Given the aforementioned deficiencies, a need exists for the monitoring, characterization, and elimination of mosquitoes. Embodiments of the present invention provide cost-effective and efficient techniques for monitoring, collecting, and destroying mosquitoes. The various embodiments utilize big data and machine learning techniques to determine the extent of mosquito activity in a given area. After mosquito activity has been detected in a given area, public officials are alerted of the need for addressing the issue.

Under certain circumstances, an embodiment of the present invention includes an insect monitoring device comprising a tube. An attractor is positioned at an entrance to the tube, and an imaging device is configured for producing data associated with a monitored insect, wherein the data being usable in machine learning.

Exemplary embodiments utilize roadway lights. Roadway lights are throughout the entire world, and therefore can be utilized with embodiments of the present invention to correlate mosquito capture and behavior to certain disease outbreak. Mosquitoes fly relatively slowly at, for example, approximately 1 mile per hour. Therefore, it is fairly easy to capture mosquitoes in order to catalog and potentially kill them. Their slow movement facilitates placement of devices on roadway lights to monitor, collect, and destroy mosquito populations.

In addition to monitoring, collecting and destroying mosquitoes, embodiments of the invention may also be used to monitor the effectiveness of treatments in a given area. In most instances, pesticides are sprayed to eliminate mosquito populations. However, areas may be repopulated with mosquitoes if weather conditions change or if there is an abundance of standing water in areas. The embodiments will also assist in both determining the effectiveness of treatments and monitoring for changes in a given area.

An additional advantage of utilizing existing roadway lights (e.g., luminaires) is that power already exists in the roadway light and the device can easily be connected to the roadway light. Once the device is connected, the device can wirelessly access a network connection, such as the internet, and transmit collected data. By utilizing data transmission, big data and incorporating machine learning, it may be possible to understand causes and distribution of mosquito-borne diseases in populations and respond quickly before things get out of control.

Embodiments of the present invention provide a technique for using an insect monitoring device. The device includes a tube, an attractor such as CO₂, heat, and/or light, and a data transmitter. The tube includes a tunnel (or chamber) a fan, and an imaging apparatus. The fan, within the device, is configured for generating an air stream in the tunnel. The imaging apparatus can either count the mosquitoes that were captured in the tube or it would capture images of the mosquitoes.

The images and/or count can be transmitted to an external source, where the information is cataloged. The catalog of information can be used to determine the mosquito population of a particular type of mosquitoes and can also be used for machine learning. In some instances, the mosquitoes are released back into the atmosphere. However, in other instances, the mosquitoes are terminated after their images have been captured.

The techniques provided by the embodiment are cost effective and efficient. The device can be placed onto a light pole in between an outdoor luminaire and a photoelectric controller on the light pole. One advantage of placing the device onto a light pole is that the light pole is already wired and includes access to power. Therefore, the insect monitoring device can essentially “clamp on” to the light pole or luminaire in a turnkey fashion. Another advantage of placing the device onto light poles is that numerous light poles are located throughout many areas, making mosquito sampling relatively easy. Thus, the devices can continually take mosquito samples in a variety of geographic areas.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### IV. BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a mosquito monitoring system constructed in accordance with an embodiment of the present invention.

FIG. 2 illustrates a mosquito monitoring device constructed in accordance with another embodiment of the present invention.

FIGS. 3a and 3b illustrates two stages of a mosquito monitoring device constructed in accordance with a third embodiment of the present invention.

FIG. 4 illustrates a mosquito monitoring device constructed in accordance with an embodiment of the present invention wherein the device the mosquito is wound up in a cartridge for later examination.

### V. DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

Reference will be made below in detail to exemplary embodiments of the inventive subject matter, examples of which are illustrated in the accompanying drawings. Wherever possible, the same reference numerals used throughout the drawings refer to the same or like parts.

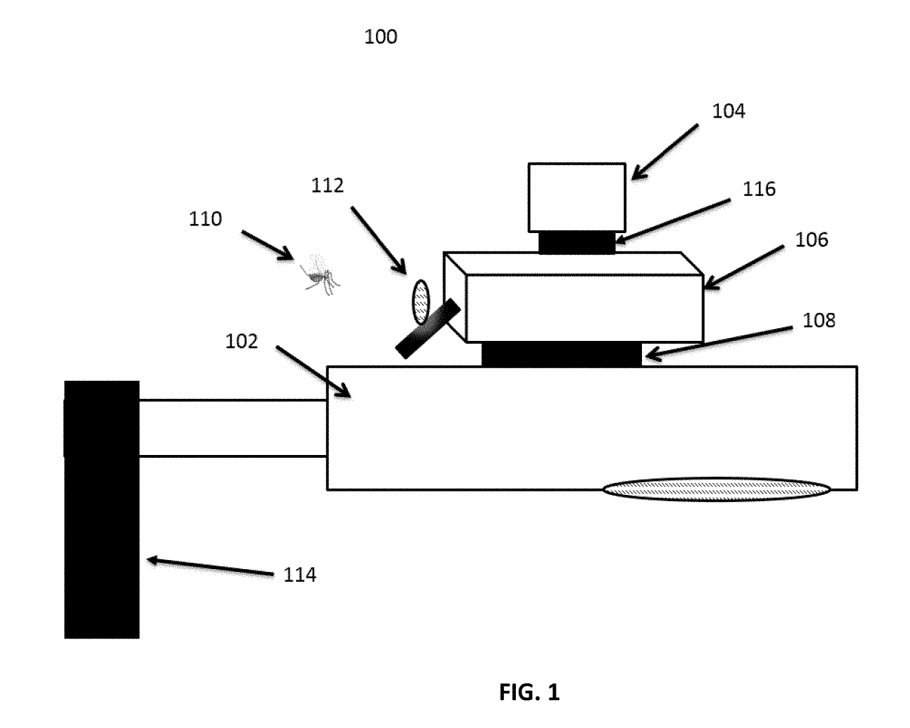

FIG. 1 illustrates a mosquito monitoring system 100. The mosquito monitoring system 100 includes a mosquito monitoring device 106 mounted onto a luminaire 102. The mosquito monitoring device 106 is mounted between a photoelectric controller 104 and a luminaire receptacle 108. However, the mosquito monitoring device 106 can be placed anywhere on the light pole 114 and is not limited to the depiction in FIG. 1. For example, the mosquito monitoring device 106 can be placed on walls, buildings, and other similar structures.

The mosquito monitoring device 106 comprises an attractor 112 either attached externally to an entrance to the mosquito monitoring device 106, or at an entrance of the mosquito monitoring device 106. Also, there are a variety of methods that can be utilized in order to capture mosquitoes alive, that are within the spirit and scope of the present invention. For example, other methods can use a funnel, a fan, and/or a container.

In FIG. 1, the mosquito monitoring device 106 is powered by the luminaire receptacle 108. The luminaire receptacle 108 may use leads (not shown) to communicate to a node that is part of the photoelectric control 104 and transmit data. The photoelectric control 104 is mounted to a receptacle 116 on the monitoring device 106 that takes the place of the luminaire receptacle 108 and carries through all appropriate connections from the luminaire 102 to the photoelectric luminaire receptacle 108. In certain embodiments, the insect monitoring device 106 may have its own method of communication and transmitting data. A mosquito 110 moves toward an attractor 112 located near or in an entrance to the mosquito monitoring device 106. The attractor 112 may be carbon dioxide (CO₂), heat, and/or light. The mosquito monitoring device 106 may utilize wireless fidelity, wireless Internet (Wi-Fi), wireless local area network (WLAN), cellular devices or similar, to transmit, store, catalog, and analyze the collected data.

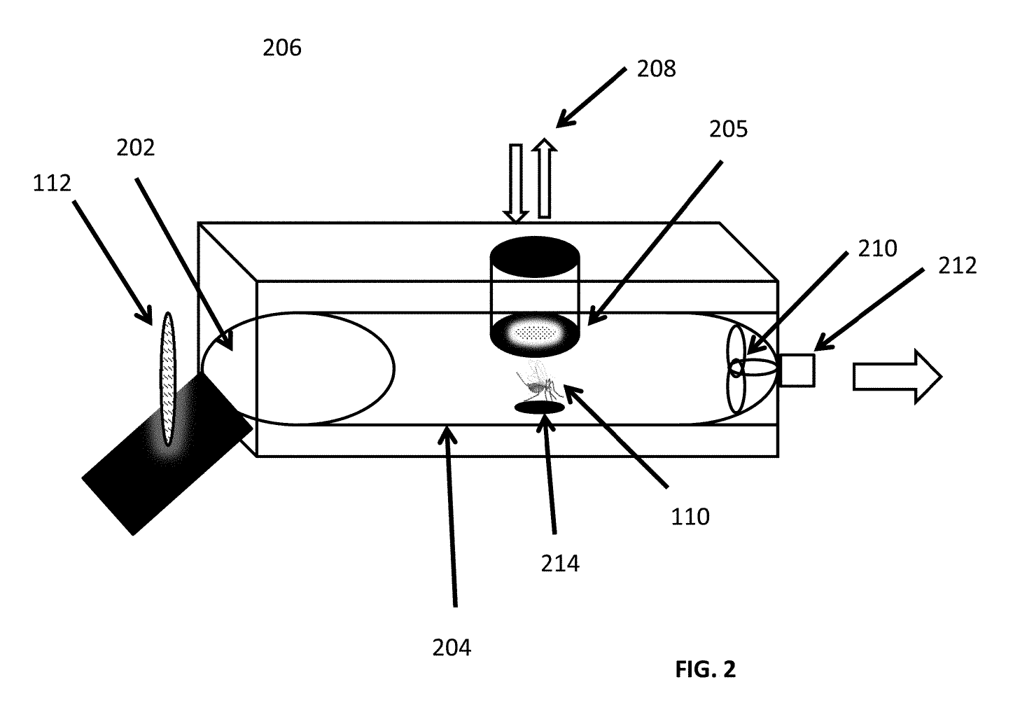

FIG. 2 illustrates a mosquito monitoring device 206 constructed and arranged in accordance with a second embodiment of the present invention. In FIG. 2, the mosquito monitoring device 206 includes the attractor 112 located near or in an entrance 202 to the mosquito monitoring device 206. A tunnel 204 is located within the mosquito monitoring device 206 and the mosquito 110 moves through the tunnel 204 nonstop. A contrast screen 214 is located within the tunnel 204. A fan 210 is affixed near an exit 212 of the tunnel 204, opposite the entrance 202. The fan 210 creates an airstream that moves the mosquito 110 through the tunnel 204.

Once the mosquito 110 moves through the tunnel 204, an imaging apparatus 205 either counts, or captures an images of, the mosquito 110 as it passes over the screen contrast 214 and consequently produces data 208. The imaging apparatus 205 is located opposed to the contrast screen 214 and the image is taken against the contrast screen 214.

While the mosquito 110 is being counted or imaged, the data 208 is transmitted from the monitoring device 206 to the photoelectric control 104 for further transmission or directly to a point of interest. The point of interest may be an external lab, screening center, or monitoring center. The data 208 is cataloged and can be used for machine learning. Once the machine learning has taken place, software associated with the mosquito monitoring device may potentially be trained to determine the population and types of mosquitoes in an area.

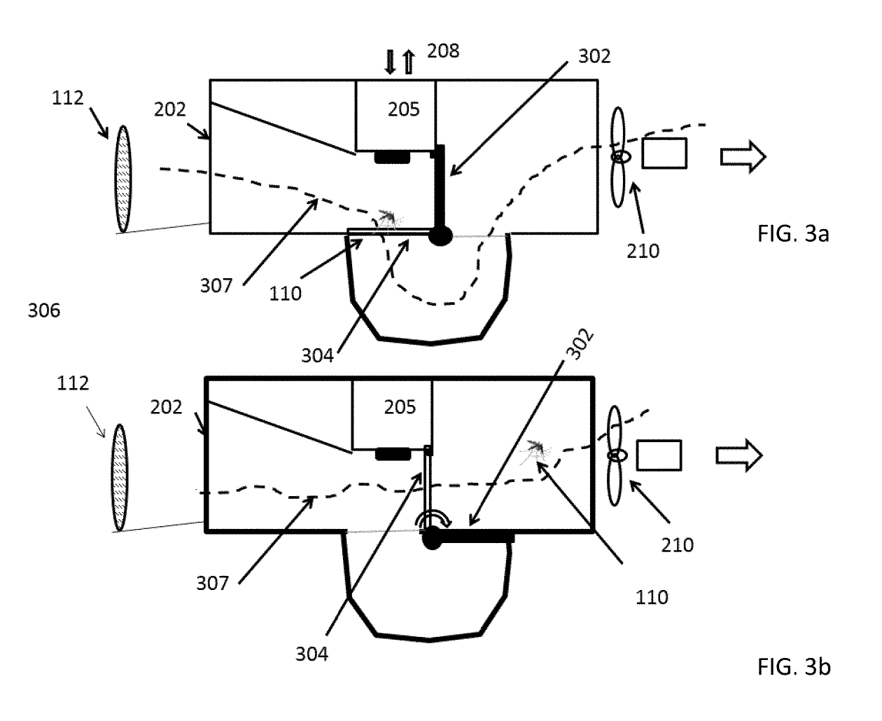

FIGS. 3a and 3b illustrate two stages of a screen suction embodiment of a mosquito monitoring device 306, wherein the mosquito is sucked onto a screen for collection of data. The mosquito monitoring device 306 comprises an attractor 112 located in or near an entrance 202 of a tunnel. The fan 210 creates an air stream 307 that moves the mosquito 110 through the tunnel. While the mosquito 110 is moving through the tunnel, and the mosquito 110 is positioned against a screen 304, as illustrated in FIG. 3a. Once the mosquito 110 is positioned opposite the imaging apparatus 205 on the screen 304, the imaging apparatus 205 either takes an image of the mosquito 110 or takes a count of the mosquito 110. The screen may potentially collect multiple mosquitoes for analysis. After a period of time, valve 302 is repositioned and the screen 304 is purged by reversing the direction of the air through, as illustrated in FIG. 3b. The entire process is repeated and the monitoring of mosquitoes is continuous.

The data 208 is transmitted from the imaging apparatus 205 to the photoelectric control 104 when the count or image is taken. The data 208 is cataloged and used for machine learning. Once the machine learning has taken place, the mosquito monitoring device 306 may potentially be used to determine the types of mosquitoes in an area. The mosquito monitoring device 306 may also be used to determine the mosquito populations in an area.

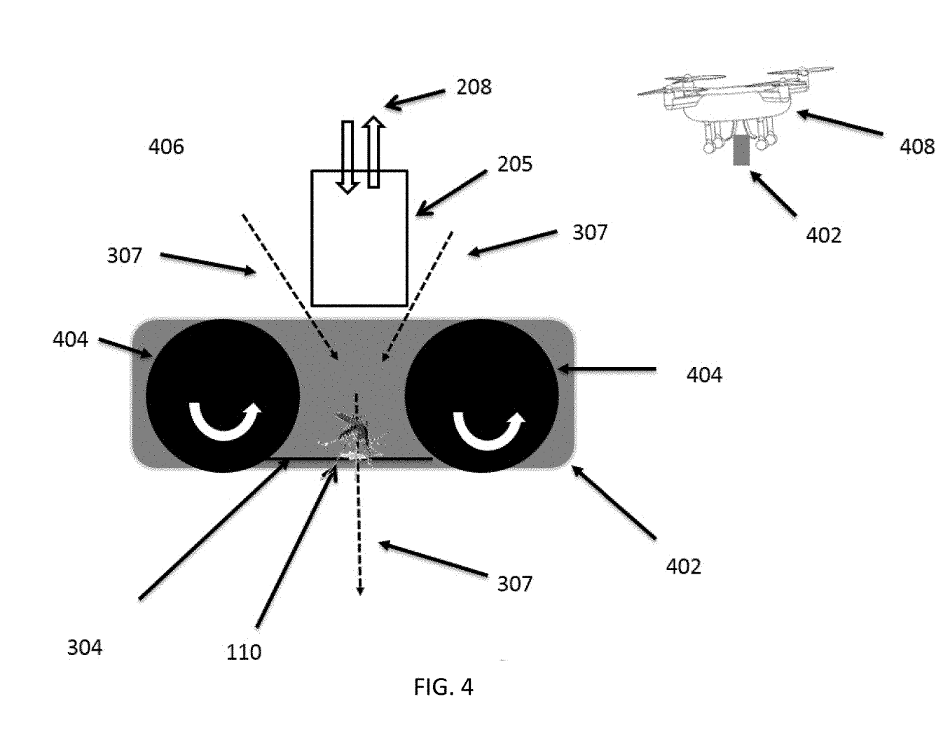

FIG. 4 illustrates yet another of a mosquito monitoring device 406 in which the mosquitoes is pulled against a screen 304 which is wound up into a roll 404 trapping the insect in the roll 404 for further examination later. The position of the insect 110 in the roll 404 can be cataloged against the corresponding images, recorded, and transmitted to an electronic storage device. When the cartridge 402 is full, the cartridge 402 can be delivered to a lab for further examination. A drone 408 or other transportation means may be used to transport the cartridge to an examining facility.

In some of the embodiments, the mosquito 110 may be released into the atmosphere, collected, or exterminated after the mosquito 110 has gone through the monitoring process. The mosquito samples may be collected into a container or a cartridge 402 as discussed and transported to a facility for analysis. The mosquitoes could either be stored on the light pole 114 and collected by a drone 408, or the mosquitoes could travel down the pole for collection. The mosquitoes could also be exterminated by using a bug zapper after the data 208 has been collected on the mosquito 110. In any of the embodiments, the fan 210 may be any type of fan such as a piezoelectric fan, a rotary fan, or similar.

There are numerous ways to attract mosquitoes including carbon dioxide (generated via a titanium oxide process) and certain wavelengths. It may be possible to change the characteristics of the attractant remotely and target specific species of mosquitoes. For example, if a specific mosquito is associated with a specific disease that particular species could be targeted by the device.

Both the contrast screen 214 and screen 304 may be any porous material which will allow air flow through with minimal pressure drop, but with holes small enough to prevent the specimen from moving through.

In certain embodiments, videos and/or pictures of the captured mosquitoes may be sent to a database to identify the strain. As discussed previously, if necessary, a drone can be sent to retrieve the sample of mosquitoes. The samples can be sent to a lab for further studies.

Alternative embodiments, examples, and modifications which would still be encompassed by the disclosure may be made by those skilled in the art, particularly in light of the foregoing teachings. Further, it should be understood that the terminology used to describe the disclosure in intended to be in the nature of words of description rather than of limitation.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A specimen monitoring device, comprising:
a tube;
an attractor positioned at an entrance to the tube; and
an imaging device configured for producing data associated with a monitored specimen, the data being usable in machine learning.

2. The specimen monitoring device of claim 1, further comprising a fan and a tunnel within the tube, the fan being configured for generating an airstream within the tunnel.

3. The specimen monitoring device of claim 1, wherein the device catalogs the produced data.

4. The specimen monitoring device of claim 1, further comprising a cartridge.

5. The specimen monitoring device of claim 4, wherein the cartridge further comprises a wind-up screen, the wind-up screen being configured to collect a set of specimen.

6. The specimen monitoring device of claim 1, wherein the data collected comprises one or more photographic images.

7. The specimen monitoring device of claim 1, wherein the produced data includes a specimen count.

8. The specimen monitoring device of claim 1, wherein the attractor includes at least one from the group including carbon dioxide, heat, and light.

9. A specimen monitoring device, comprising:
an elongated housing;
an attracting device positioned at one end of the housing for attracting a specimen;
a fan positioned in the vicinity of the elongated housing for creating an airflow, the airflow being configured for moving an attracted specimen through the housing to a capture device; and
an imager configured for creating data associated with the specimen captured in the capture device; and
a transmitter configured for transmitting the created data.

10. The specimen monitoring device of claim 9, wherein the capture device is a screen.

11. The specimen monitoring device of claim 9, wherein the specimen monitoring device is mounted on an outdoor luminaire.

12. The specimen monitoring device of claim 9, further comprising a valve configured to cut off an air stream in the tunnel and pull the specimen against a screen.

13. The specimen monitoring device of claim 12, wherein the valve being further configured to change the direction of the air stream and blow the specimen off of the screen.

14. The specimen monitoring device of claim 9, wherein the device is located between a photoelectric controller and a photoelectric receptacle on an outdoor luminaire.

15. The specimen monitoring device of claim 9, wherein the device is configured to catalog the specimen activity in a designated area.

16. The specimen monitoring device of claim 9, further comprising a housing exit configured for releasing the specimen.

17. A method of monitoring a specimen in a geographic area via a specimen monitoring device, the method comprising:
attracting the specimen to the specimen monitoring device via an attraction device;
pulling the specimen into a chamber of the device;
capturing an image of the specimen within the chamber; and
analyzing the captured image to produce image data.

18. The method of claim 17, further comprising cataloging image data.

19. The method of claim 17, further comprising providing the image data to a data base for machine learning.

20. The method of claim 19, further comprising releasing the specimen through an exit of the device.
